(19) United States
(12) Patent Application Publication
(10) Pub. No.: US 2006/0136640 A1
(43) Pub. Date: Jun. 22, 2006

(54) Apparatus and method for hardware semaphore

(76) Inventor: Cheng-Ming Tuan, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 11/116,972

(22) Filed: Apr. 28, 2005

(30) Foreign Application Priority Data
Dec. 17, 2004 (TW) 093139423

(51) Int. Cl. G06F 12/14; G06F 13/24

(52) U.S. Cl. 710/260; 710/200

(57) ABSTRACT

A device and method for hardware semaphore is provided to be used in a multi-processor system. The device for hardware semaphore comprises a plurality of semaphores, a semaphore module register set, a control logic unit, a bus interface unit, and an interrupt generation unit. According to the invention, a single read operation of a memory location can allocate or acquire a semaphore, the hardware control logic circuit atomically execute the test and set operations. A hardware semaphore itself is considered as a shared resource. The multi-processor system can use a single read operation to request for the allocation of a specific or a random semaphore. The multi-processor system can also use a single read operation to request for the acquisition of a specific semaphore. The hardware semaphore device sets up interrupt signals to notify the processors in the system about the release of a semaphore which the processors fail to acquire.

### FIELD OF THE INVENTION

The present invention generally relates to a computer system, and more specifically to an apparatus and a method for hardware semaphore. It can be applied to multi-processor systems.

### BACKGROUND OF THE INVENTION

The semaphores are used by an operating system or application software to manage one or more shared resources. There are four interface functions to the semaphores by the software, including create semaphore, wait semaphore, release semaphore, and free semaphore. By calling the interface function of create semaphore with an initial value indicating the number of the resource units for sharing, the operating system or application software is able to manage the shared resources.

Before a process starts to use the shared resources, the process calls the wait semaphore interface function of that corresponding semaphore. If the return value of the corresponding semaphore is zero, it implies that all the shared resources are currently in use, and the process enters the waiting state. On the other hand, when the return value is non-zero (test phase), the semaphore is decremented by 1 (set phase), and the process starts to use the shared resource. It is important that the test phase and the set phase of the semaphore must be atomic; that is, requests to the same semaphore from different processes cannot be interleaved.

When the process finishes the use of shared resource, the process calls the release semaphore interface function, and the semaphore is incremented by 1. If there are other processes in the waiting state, they can start to use the shared resource.

Finally, when the operating system or the application software no longer requires managing the shared resources, the free semaphore interface function can be called to eliminate the semaphore or free it for managing other shared resources.

There are several ways to implement the semaphore mechanism. In a single-processor system, software mechanism (e.g. critical section) or instructions (e.g. swap) can be used. In the multi-processor system, it requires hardware mechanism, such as lock bus, or special-purpose hardware modules. However, the lock bus will degrade the performance of the system while the hardware semaphore will not.

When a plurality of processes use a shared resource, a semaphore is required for the coordination and synchronization. Otherwise, the contention will occur. In addition to the use of the semaphore, the system also require an atomic operation including a test and a set of the semaphore to avoid contention of the shared resource.

In U.S. Patent publication 2003/0,149,820, Kolinummi disclosed a hardware semaphore applicable to a multi-processor system. Any processor can issue a read operation to the semaphore before reserving or using a shared resource. The logic circuit of the semaphore ensures that the reservation or use of semaphore is an atomic operation; therefore, the processor and the bus need not support the atomic operation. The disadvantage of Kolinummi's invention is that it does not support dynamic allocation of the semaphore, which is also a shared resource. Also, the handling of the interrupt signal is not complete.

In U.S. Patent No. 2004/0,019,722, Sedmak disclosed a method and a device of a semaphore used in a multi-core processor. The multi-core processor includes a central arbitration unit connected to every core. The method includes the steps of: (a) each core sending a first signal to the central arbitration unit to request a shared resource for executing a first operation, and (b) each core receiving a second signal from the central arbitration unit and executing the first operation. The device requires specific hardware interface and additional control signal lines.

Numerous hardware semaphores have been proposed. However, most of the proposed hardware semaphores either require specific hardware interface and additional control signal lines, or require defining specific commands. They usually do not satisfy the criteria of a hardware semaphore device, which are low cost, structural simplicity, safety and ease of use.

### SUMMARY OF THE INVENTION

The present invention has been made to overcome the aforementioned drawback of conventional hardware semaphores. The primary object -of the present invention is to provide a hardware semaphore device applicable to multi-processor systems. Every processor in the multi-processor system can independently access the hardware semaphore device through a bus matrix.

The hardware semaphore device comprises a plurality of semaphores, a semaphore module register set, a control logic unit, a bus interface unit, and an interrupt generation unit. Every semaphore is arranged to manage a shared resource. The semaphore module register set stores the allocation information of the semaphores, and the control logic unit is electrically connected to the semaphores and the semaphore module register set, respectively. The bus interface unit has two ends, with one end connecting to control logic unit, and the other connecting to each processor through the bus matrix. The interrupt generation unit also has two ends, with one end connecting to control logic unit, and the other connecting to each processor (or processor's interrupt controller) through at least an interrupt signal line.

Another object of the present invention is to provide a method applicable to a multi-processor system for realizing the hardware semaphore device. Each semaphore of the hardware semaphore device includes at least a remaining resource number register, an initial resource number register, a waiting list register, and a set waiting register. The semaphore module register set of the hardware semaphore device includes at least a random allocation register, an interrupted processor list register, and a plurality of allocation registers. After the system finishing the initialization stage, the system allocates at least a semaphore to manage and connect to at least a shared resource of the system, respectively. Any processor wishes to use the shared resource must acquire the corresponding semaphore before accessing the shared resource. After finishing using the shared resource, the processor must release the semaphore for other processors to acquire. For the shared resource that is no longer in use, the corresponding semaphore is freed.

The major feature of the present invention is to use the hardware semaphore as a shared resource, and the semaphore can be dynamically allocated in run time. The system only needs to issue a read operation to the random allocation register or the allocation register of the semaphore module register set, and a semaphore is allocated to manage a shared resource. The logic circuit ensures the allocation is performed in an atomic operation. The system only needs to issue a read operation to the remaining resource number register of the semaphore in order to acquire the semaphore for accessing a shared resource. Finally, when failing to acquire the semaphore, the present invention sets the interrupt to inform the system; therefore, no periodic polling is required, and the performance can be improved.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of the structure of a multi-processor system in which the present invention of a hardware semaphore device is applicable.

FIG. 2 shows a schematic view of the structure of a hardware semaphore device of the present invention.

FIGS. 3A and 3B show respectively the semaphore module register set and the registers in the semaphore.

FIG. 4A shows a working flow for the hardware of the control logic unit.

FIG. 4B shows a working flow for the hardware of the control logic unit when the system requests a random allocation of a semaphore.

FIG. 4C shows a working flow for the hardware of the control logic unit when the system requests the allocation of a specific semaphore.

FIG. 4D shows a working flow for the hardware of the control logic unit when the system requests to acquire a semaphore.

FIG. 4E shows a working flow for the hardware of the control logic unit when the system requests to release a semaphore.

FIG. 4F shows a working flow for the hardware of the control logic unit when the system requests to free a semaphore.

FIG. 5 shows a flowchart illustrating the operation of a hardware semaphore device of FIG. 2, in which the hardware semaphore device is applicable to a multi-processor system.

FIG. 6 shows a flowchart illustrating the operation of requesting a random semaphore.

FIG. 7 shows a flowchart illustrating the operation of requesting a specific semaphore.

FIG. 8 shows a flowchart illustrating the operation of requesting the acquisition of a semaphore.

FIG. 9 shows a flowchart illustrating the operation upon receiving an interrupt signal.

### DETAILED DESCRIPTION OF THE PREFERRED EMBODIMENTS

The present invention uses hardware to realize a semaphore and related four software interfaces, including create semaphore, wait semaphore, release semaphore, and free semaphore. The four software interfaces corresponding to the present invention are allocate a semaphore, acquire a semaphore, release a semaphore, and free a semaphore.

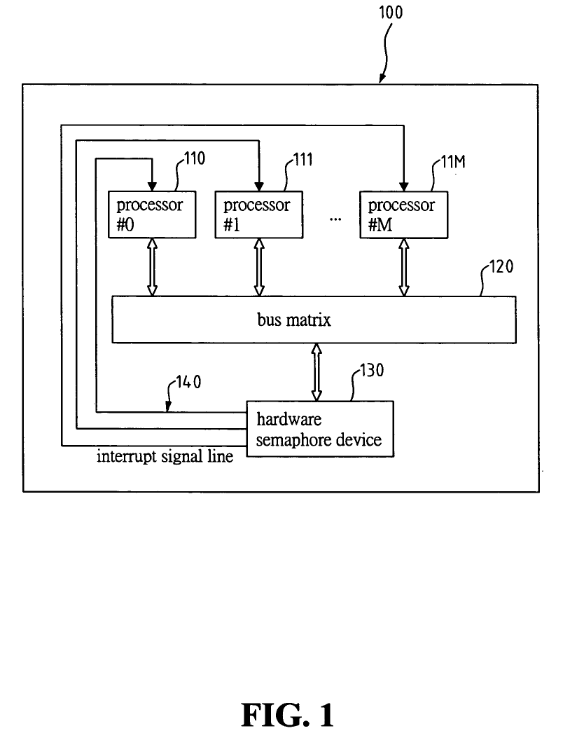

FIG. 1 shows the structure of a multi-processor system, in which the hardware semaphore device according to the invention can be applied. As shown in FIG. 1, a hardware semaphore device 130 of the present invention is applied in a multi-processor system 100. Multi-processor system 100 may be, but not limited to, a system-on-chip (SoC) having a plurality of processors 110-11M, which can independently access hardware semaphore device 130 through a bus matrix 120. Hardware semaphore device 130 uses an interrupt signal line 140 to connect each processor 110-11M or the interrupt controller (not shown) of each processor 110-11M.

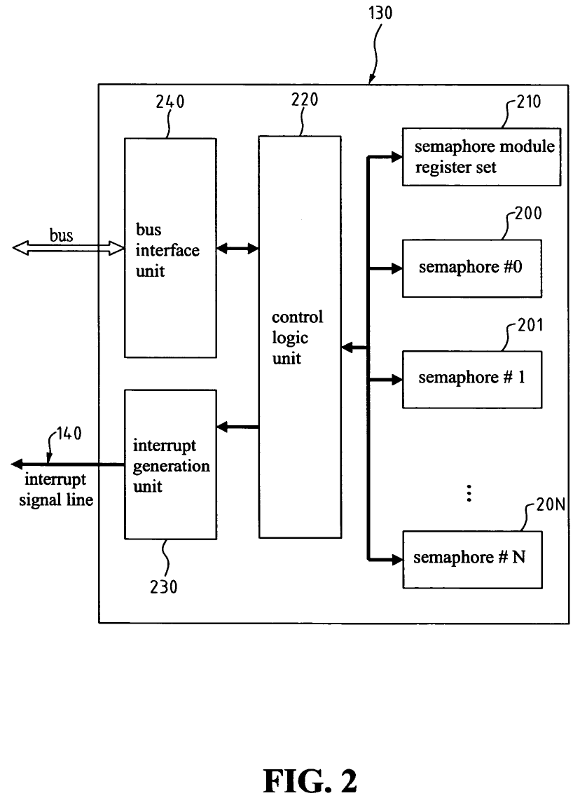

FIG. 2 shows a structure of a hardware semaphore device of the present invention. As shown in FIG. 2, hardware semaphore device 130 includes a plurality of semaphores 200-20N, a semaphore module register set 210, a control logic unit 220, a bus interface unit 240, and an interrupt generation unit 230. Each semaphore 200-20N is arranged to manage a shared resource. Semaphore module register set 210 stores the allocation information of semaphores 200-20N. Control logic unit 220 is electrically connected to semaphore 200-20N and semaphore module register set 210, respectively. Bus interface unit 240 has two ends, with one being connected to control logic unit 220, and the other being connected to each processor 110-11M through bus matrix 120. Interrupt generation unit 230 also has two ends, with one being connected to control logic unit 220, and the other being connected to each processor 110-11M through at least an interrupt signal line 140. The bus includes a reset line, an enable line, a clock line, a write line, a plurality of address lines, a plurality of write data lines and a plurality of read data lines.

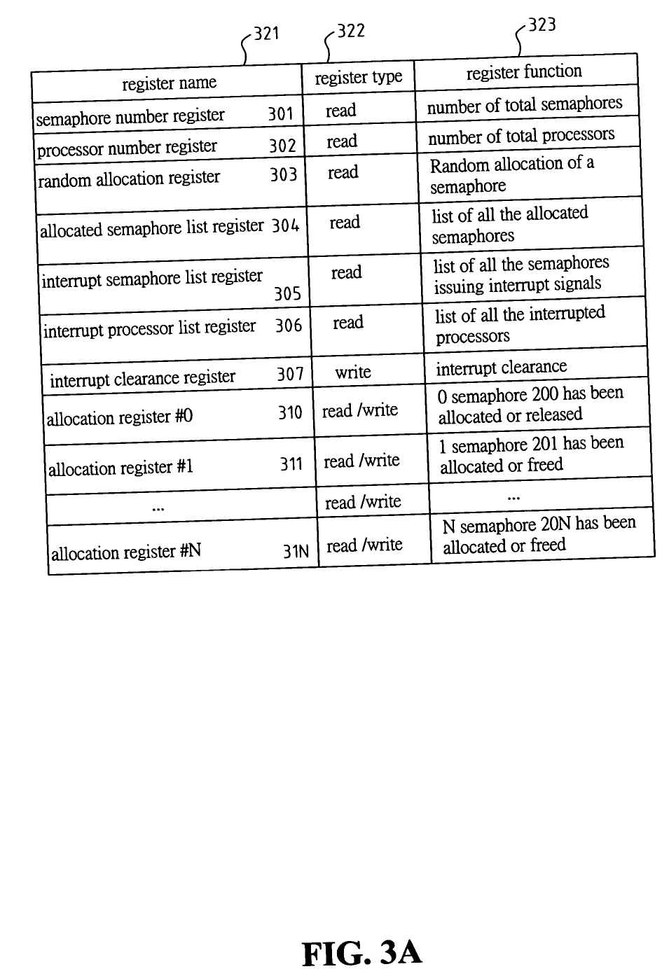

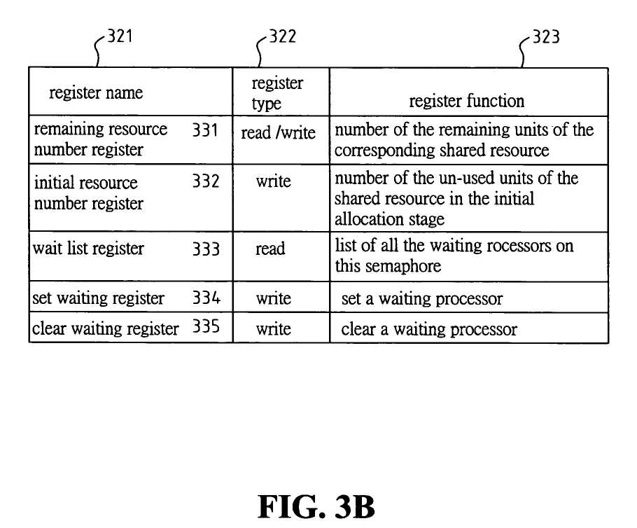

FIG. 3A and FIG. 3B show the semaphore module register set and the registers included in the semaphore, respectively. As shown in FIG. 3A, a field 321 is the register name, a field 322 is the register type (read and/or write), and a field 323 is the register function. Semaphore module register set 210 includes a semaphore number register 301, a processor number register 302, a random allocation register 303, an allocated semaphore list register 304, an interrupt semaphore list register 305, an interrupt processor list register 306, an interrupt clearance register 307, and a plurality of allocation registers 310-31N. It is worth noticing that the size and the number of the registers can be varied to meet the different system requirements.

Semaphore number register 301 is for storing the number of total semaphores. Processor number register 302 is for storing the number of total processors in system 100. Random allocation register 303 is for returning the number of a non-allocated semaphore after receiving a read operation from any processor 11M. Allocated semaphore list register 304 is for storing the bits representing the list of all the allocated semaphores. Interrupt semaphore list register 305 is for storing the bits representing the list of all the semaphores issuing interrupt signals. The system can consult interrupt semaphore list register to find the semaphores issuing interrupt after released. Interrupt processor list register 306 is for storing the bits representing the list of all the interrupted processors, so that interrupt generation unit 230 can generate interrupts to notify the interrupted processors individually. Interrupt clearance register 307 is for writing the number of a processor for clearing the corresponding bit in interrupt processor list register 306. The plurality of allocation registers 310-31N correspond to the semaphores 200-20N for indicating if the semaphore has been allocated.

As shown in FIG. 3B, each semaphore 200-20N at least includes a remaining resource number register 331, an initial resource number register 332, a waiting list register 333, a set waiting register 334, and a clear waiting register 335. Remaining resource number register 331 is for storing the number of the remaining units of the corresponding shared resource. When receiving a read operation of remaining resource number register 331, control logic unit 220 returns the number stored in remaining resource number register 331, which represents the number of the un-used units in the resource. Initial resource number register 332 is for the system to write the number of the un-used units of the shared resource in the initial allocation stage. Waiting list register 333 is for storing the bits representing the list of all the waiting processors on this semaphore. Set waiting register 334 is for the system to write the number of a processor in order to set the corresponding bit in the waiting list register 333. Clear waiting register 335 is for writing the number of a processor in order to clear the corresponding bit in the waiting list register 333.

Control logic unit 220 of the present invention includes a hardware logic circuit that can atomically execute the test and set operations by a read operation issued by the system to random allocation register 303 and allocation registers 310-31N of semaphore module register set 210, or remaining resource number register 331 of semaphores 200-20N. Processors 110-11M and bus 120 of system 100 need not support 20 atomic read/write operation. This design simplifies the system structure and the commands, and is also safe to use.

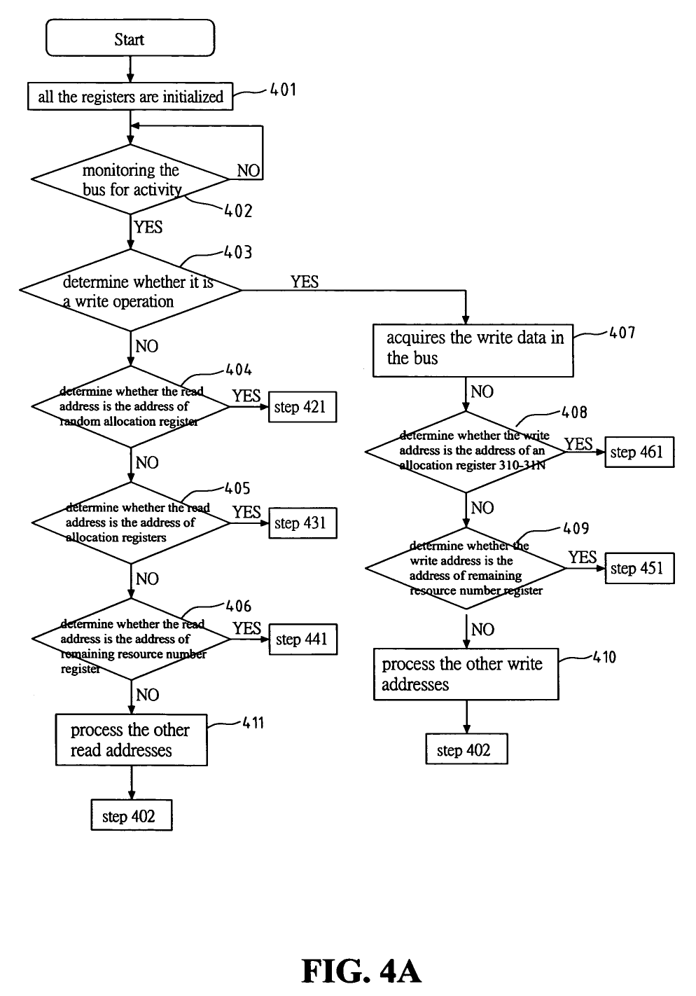

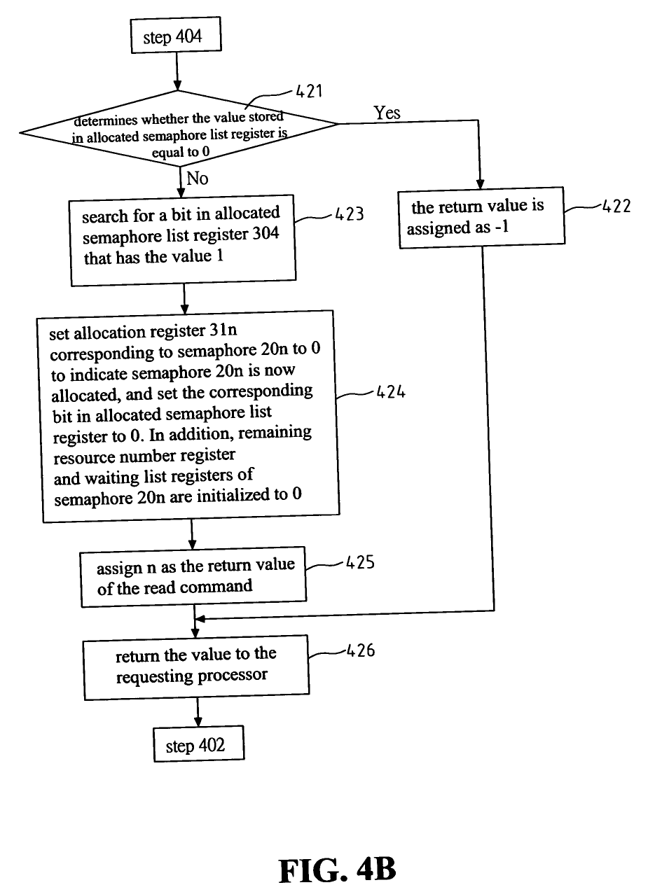

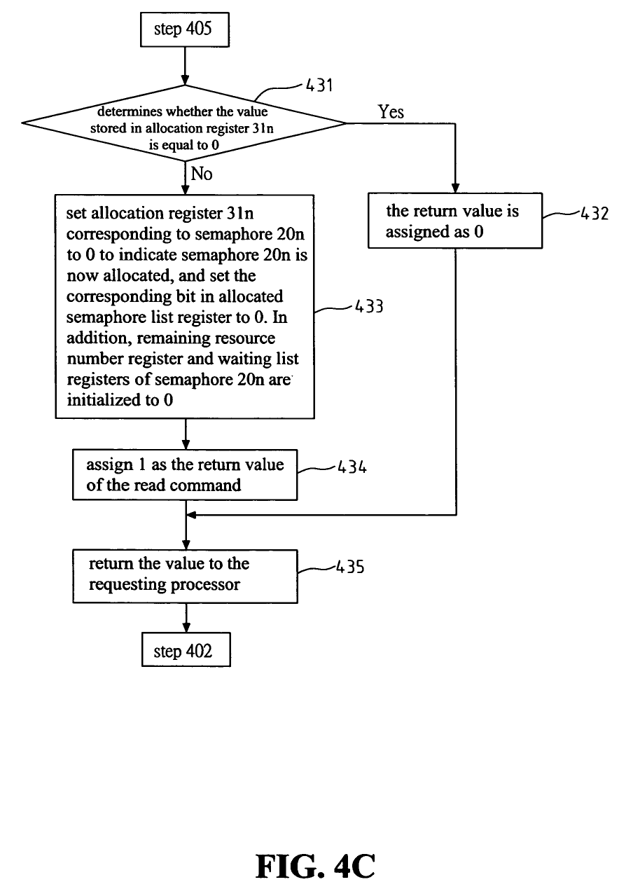

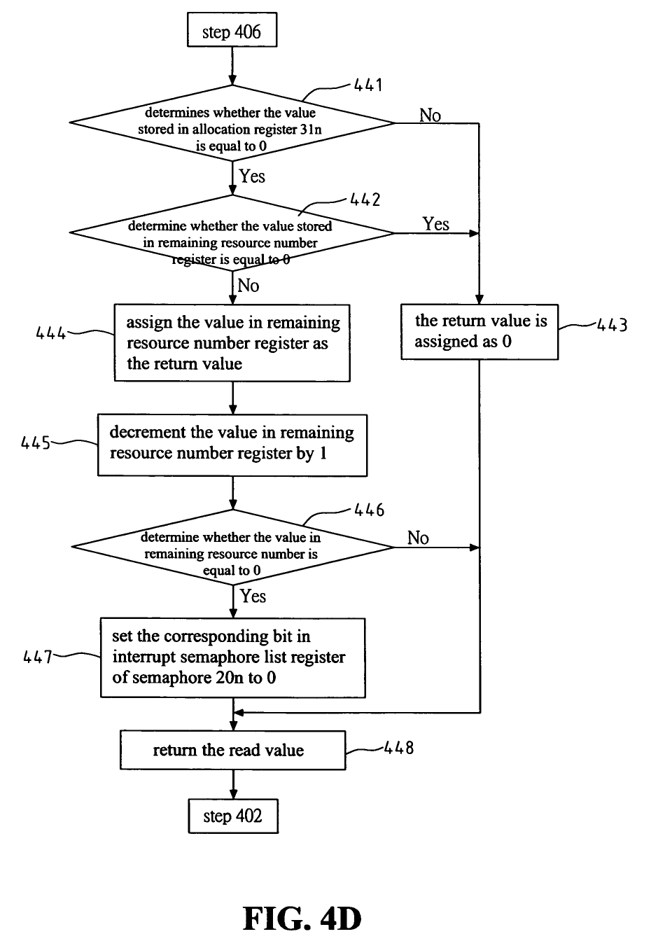

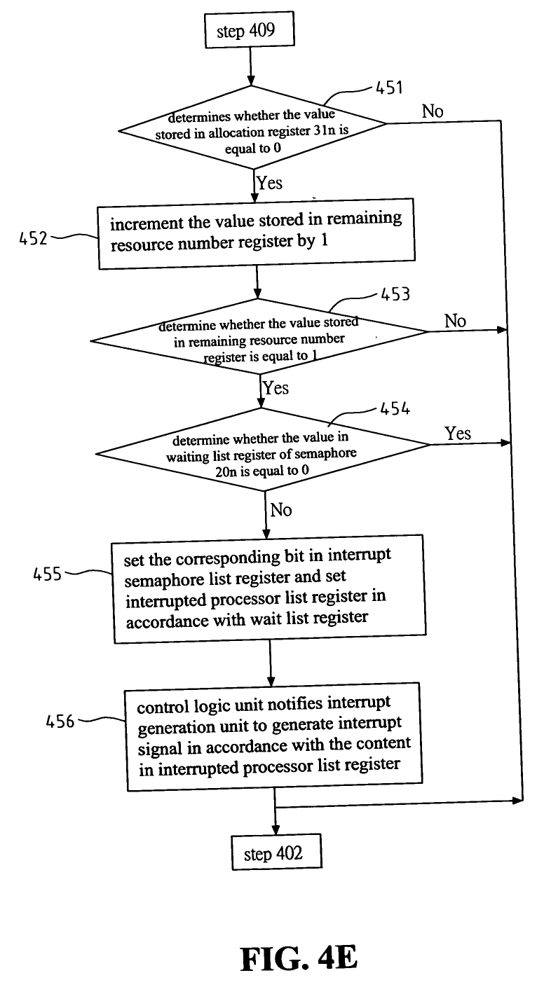

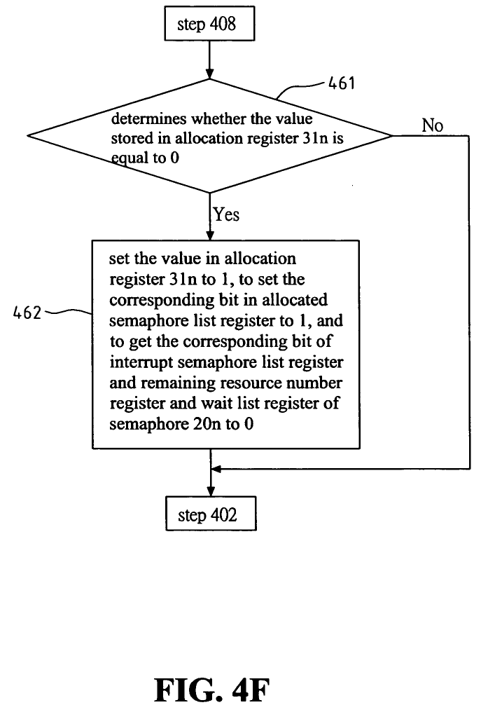

FIG. 4A shows a flowchart illustrating the hardware operation of the control logic unit. FIG. 4B shows a flowchart illustrating the operation of the control logic unit when the system requests a random allocation of a semaphore. FIG. 4C shows a flowchart illustrating the operation of the control logic unit when the system requests the allocation of a specific semaphore. FIG. 4D shows a flowchart illustrating the operation of the control logic unit when the system requests to acquire a semaphore. FIG. 4E shows a flowchart illustrating the operation of the control logic unit when the system requests to release a semaphore. FIG. 4F shows a flowchart illustrating the operation of the control logic unit when the system requests to free a semaphore.

As shown in FIG. 4A, in step 401, all the registers are initialized when hardware semaphore device 130 is powered on. In step 402, control logic unit 220 monitors the bus for activity. If no activity is observed, the monitoring continues. Step 403 is to acquire the address information in the bus and to determine whether it is a write operation. If so, proceed to step 407. Step 404 is to determine whether the read address is the address of random allocation register 303. If so, proceed to step 421. Step 405 is to determine whether the read address is the address of allocation registers 310-31N. If so, proceed to step 431. Step 406 is to determine whether the read address is the address of remaining resource number register 331 of a semaphore. If so, proceed to step 441; otherwise, return to step 402 after processing the other read addresses (step 411). In step 407, control logic unit 220 acquires the write data in the bus. Step 408 is to determine whether the write address is the address of an allocation register 310-31N. If so, proceed to step 461. Step 409 is to determine whether the write address is the address of remaining resource number register 331 of a semaphore. If so, proceed to step 451. Step 410 is to process the other write addresses and return to step 402.

As shown in step 421 of FIG. 4B, when a processor 110-11M of system 100 requests a random allocation of a semaphore by issuing a read operation to random allocation register 303, control logic unit 220 determines whether the value stored in allocated semaphore list register is equal to 0. If the value is equal to 0, indicating all the semaphores are allocated, the return value is assigned as −1, as in step 422. Otherwise, search for a bit in allocated semaphore list register 304 that has the value 1, as in step 423. An n-th bit equal to 1 implies that semaphore 20n is not yet allocated. Set allocation register 31n corresponding to semaphore 20n to 0 to indicate semaphore 20n is now allocated, and set the corresponding bit in allocated semaphore list register 304 to 0. In addition, remaining resource number register 331 and waiting list registers of semaphore 20n are initialized to 0, as in step 424. Step 425 is to assign n as the return value of the read operation, and step 426 is to return the value to the requesting processor.

As shown in step 431 of FIG. 4C, when a processor 110-11M of system 100 requests a specific semaphore by issuing a read operation to allocation register 31n, control logic unit 220 determines whether the value stored in allocation register 31n is equal to 0. If the value is equal to 0, indicating semaphores 20n has been allocated, the return value is assigned as 0, as in step 432. Otherwise, set allocation register 31n corresponding to semaphore 20n to 0 to indicate semaphore 20n is now allocated, and set the corresponding bit in allocated semaphore list register 304 to 0. In addition, remaining resource number register 331 and waiting list registers of semaphore 20n are initialized to 0, as in step 433. Step 434 is to assign 1 as the return value of the read operation, and step 435 is to return the value to the requesting processor.

As shown in step 441 of FIG. 4D, control logic unit 220 determines whether the value stored in allocation register 31n is equal to 0 when a processor 110-11M of system 100 requests to acquire a specific semaphore and issues a read operation to remaining resource number register 331 of semaphore 20n. If the value is not equal to 0, indicating semaphores 20n is not yet allocated and cannot be acquired, the return value is assigned as 0 to indicate the failure of acquisition request, as in step 443. Otherwise, determine whether the value stored in remaining resource number register 331 is equal to 0, as in step 442. If so, proceed to step 443; otherwise, assign the value in remaining resource number register 331 as the return value (step 444), and decrement the value in remaining resource number register by 1 (step 445). Step 446 is to determine whether the value in remaining resource number is equal to 0. If so, set the corresponding bit in interrupt semaphore list register 305 of semaphore 20n to 0, as in step 447. Finally, step 448 is to return the read value.

According to the present invention, when the system finishes the use of a shared resource, the system must release a semaphore 20n by writing any value to remaining resource number register 331 of semaphore 20n. As shown in step 451 of FIG. 4E, control logic unit 220 determines whether the value stored in allocation register 31n is equal to 0, indicating corresponding semaphore 20n being allocated. If the value is not equal to 0, the process terminates. Otherwise, step 452 is to increment the value stored in remaining resource number register 331 by 1. Step 453 is to determine whether the value stored in remaining resource number register 331 is equal to 1. If not, the process terminates, as in step 453. Step 454 is to determine whether the value in waiting list register 333 of semaphore 20n is equal to 0; if so, it indicates that no processor is waiting for the semaphore, and the process can terminate. Otherwise, take step 455 to set the corresponding bit in interrupt semaphore list register 305 and set interrupted processor list register 306 in accordance with wait list register 333. Finally, control logic unit 220 notifies interrupt generation unit 230 to generate interrupt signal in accordance with the content in interrupted processor list register 306, as in step 456.

According to the present invention, when the system no longer wishes to use a shared resource, the system must free a semaphore 20n by writing any value to remaining resource number register 331 of semaphore 20n. As shown in step 461 of FIG. 4F, control logic unit 220 determines whether the value stored in allocation register 31n is equal to 0, indicating corresponding semaphore 20n being allocated. If the value is not equal to 0, the process terminates. Otherwise, step 462 is to set the value in allocation register 3 In to 1, to set the corresponding bit in allocated semaphore list register 304 to 1, and to set the corresponding bit of interrupt semaphore list register 305, remaining resource number register 331 and wait list register 333 of semaphore 20n to 0.

When an operating system or application needs to manage one or more shared resources, the create semaphore programming interface used by conventional technologies can be mapped to the process of either random allocation of semaphore or allocation of a specific semaphore of the present invention. The choice is within the arbitration of the system designer and beyond the scope of the present invention. As the hardware semaphore itself is also a shared resource, the allocation of semaphore must be also atomic.

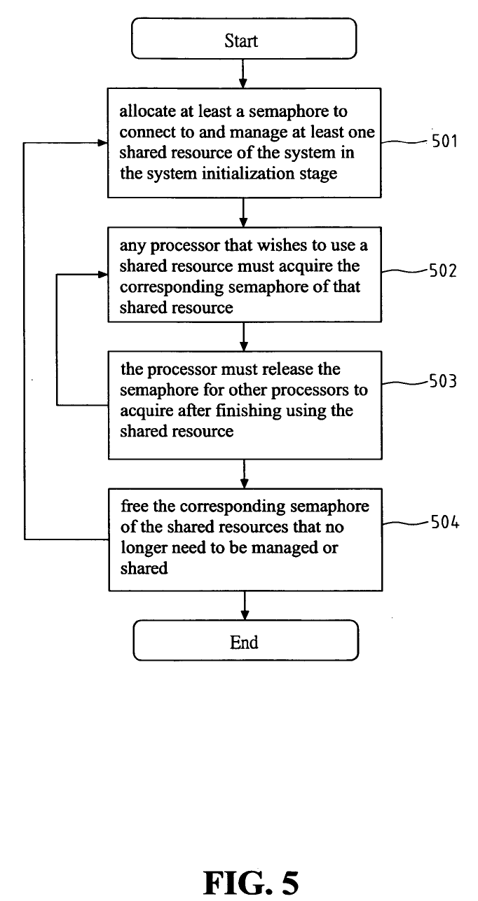

FIG. 5 shows a flowchart illustrating the operation of a hardware semaphore device of FIG. 2, in which the hardware semaphore device is applicable to a multi-processor system. Each semaphore of the hardware semaphore device includes at least a remaining resource number register, an initial resource number register, a wait list register and a set wait register. The semaphore module register set includes at least a random allocation register, an interrupted processor list register and a plurality of allocation registers.

As shown in FIG. 5, step 501 is for the system to allocate at least a semaphore to connect to and manage at least one shared resource of the system in the system initialization stage. In step 502, any processor that wishes to use a shared resource must acquire the corresponding semaphore of that shared resource. In step 503, the processor must release the semaphore for other processors to acquire after finishing using the shared resource. Step 504 is to free the corresponding semaphore of the shared resources that no longer need to be managed or shared. Similarly, when a new shared resource is connected to the system, a previously freed semaphore can be allocated to connect to and manage the newly added shared resource.

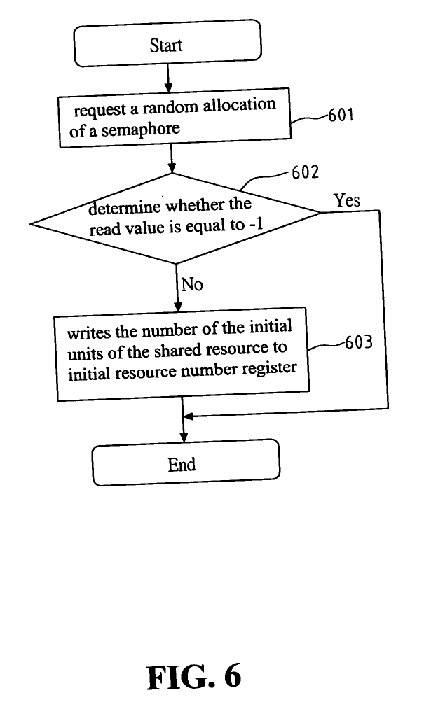

FIG. 6 shows a flowchart illustrating the operation to request a random allocation of a semaphore according to the present invention. As shown in FIG. 6, step 601 is for an application to request a random allocation of a semaphore 200-20N by reading random allocation register 303. Step 602 is to determine whether the read value is equal to −1; if so, it indicates that all the semaphores are allocated and the request fails. Otherwise, the return value n is the allocated semaphore. The logic circuit in control logic unit 220 will mark semaphore 20n as allocated by setting allocation register 31n to 0 (as step 424 of FIG. 4B). In step 603, the application writes the number of the initial units of the shared resource to initial resource number register 332 and terminates. At the same time, the logic circuit in control logic unit 220 will automatically writes the initial value to the remaining resource number register 331. At this point, the semaphore is successfully allocated and initialized.

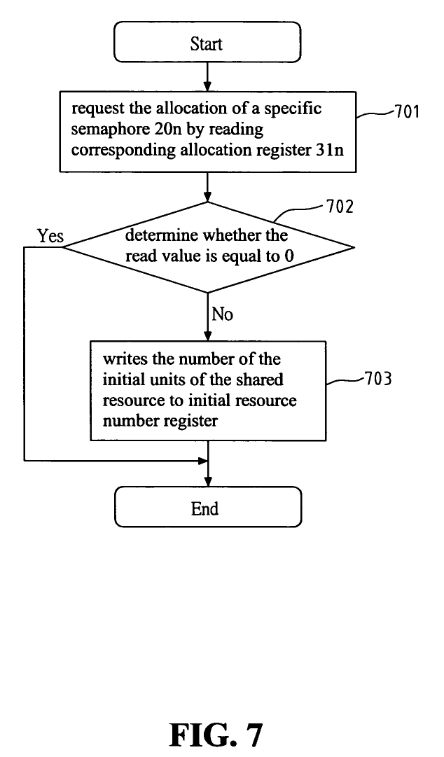

FIG. 7 shows a flowchart illustrating the operation of requesting to allocate a specific semaphore according to the present invention. As shown in FIG. 7, step 701 is for an application to request the allocation of a specific semaphore 20n by reading corresponding allocation register 31n. Step 702 is to determine whether the read value is equal to 0; if so, it indicates that semaphore 20n has been allocated and the request fails. Otherwise, the specific semaphore is successfully allocated. The logic circuit in control logic unit 220 will mark semaphore 20n as allocated by setting allocation register 31n to 0 (as step 433 of FIG. 4C). In step 703, the application writes the number of the initial units of the shared resource to initial resource number register 332 and terminates. At the same time, the logic circuit in control logic unit 220 will automatically writes the initial value to the remaining resource number register 331. At this point, the semaphore is successfully allocated and initialized.

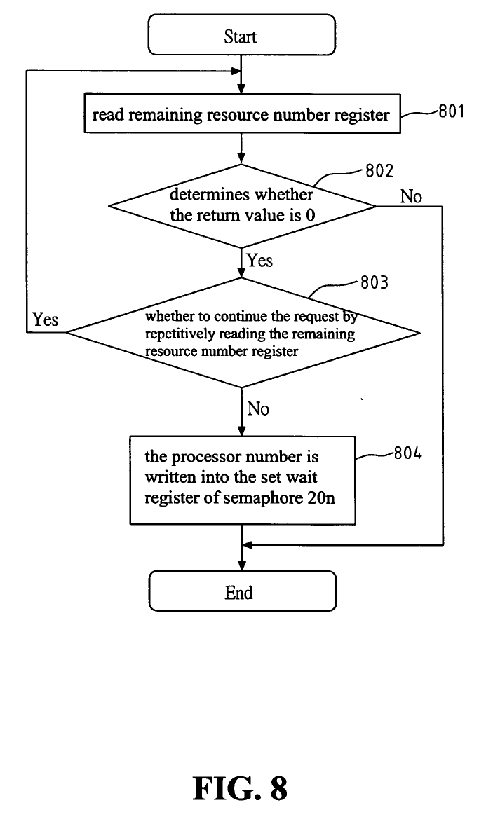

FIG. 8 shows a flowchart illustrating the operation of requesting to acquire a specific semaphore according to the present invention. A shared resource is managed by a semaphore 20n of the present invention. The call to the wait semaphore interface corresponds to the acquire semaphore 20n process of the present invention. As shown in FIG. 8, step 801 is for the requesting process to read remaining resource number register 331 of semaphore 20n. Step 802 determines whether the return value is 0. If not, the acquisition is successful and the requesting process can start to use the shared resource. At the same time, the logic circuit in control logic unit 220 automatically decrements the value in remaining resource number register 331 of semaphore 20n by 1 (as step 445 of FIG. 4D). Otherwise, the acquisition is failed and the value in remaining resource number register 331 stays unchanged, and the requesting process is not allowed to use the shared resource. In step 803, the requesting process determines whether to continue the request by repetitively reading the remaining resource number register; if so, return to step 801. In step 804, the requesting process writes processor number into the set wait register 334 of semaphore 20n to set the notification target for an interrupt signal when semaphore 20n is released, and the requesting process enters the state of waiting for the interrupt signal.

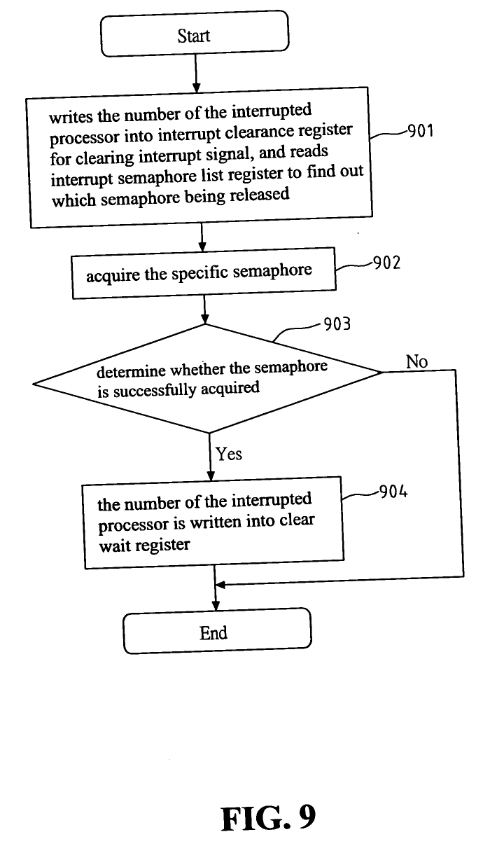

FIG. 9 shows a flowchart illustrating the operation of receiving an interrupt signal according to the present invention. When a semaphore is released, all the processors recorded in wait list register 333 will be notified with an interrupt signal. As shown in step 901 of FIG. 9, the interrupted processor receives an interrupt signal, writes the number of the interrupted processor into interrupt clearance register 307 for clearing interrupt signal, and reads interrupt semaphore list register 305 to find out which semaphore being released. Step 902 is to acquire the specific semaphore by following the operation in FIG. 8. Step 903 is to determine whether the semaphore is successfully acquired; if not, continue the waiting for an interrupt signal and the process terminates. In step 904, the number of the interrupted processor is written into clear wait register 335. The logic circuit of control logic unit 220 automatically clears the corresponding bit of wait list register 333. The processor can start to use the shared resource.

When any processor in multi-processor 100 finishes the use of a shared resource, the processor releases semaphore 20n by writing any value to remaining resource number register 331 of semaphore 20n. The logic circuit of control logic unit 220 automatically executes the operation shown in FIG. 4E. Similarly, when multi-processor system 100 no longer wishes to manage and use the shared resource, the system can free semaphore 20n by writing any value to corresponding allocation register 31n. Finally, the logic circuit of control logic unit 220 automatically executes the operation shown in FIG. 4F.

The present invention is applicable to a multi-processor system implemented within an application specific integrated circuit (ASIC) chip or a system-on-a-chip (SoC). The present invention is resident in the same chip. On the other hand, the present invention is also applicable to a multi-processor system implemented with a plurality of individual processor chips. In this case, the present invention can be on a different chip.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hardware semaphore device applicable to a multi-processor system having a bus matrix to independently read/write said hardware semaphore device, said hardware semaphore device comprising:
a plurality of semaphores, each said semaphore being arranged to manage a shared resource;
a semaphore module register set, for storing allocation information of said semaphore;
a control logic unit, electrically connected to said semaphores and said semaphore module register set respectively;
a bus interface unit, having two ends, with one said end connecting to said control logic unit, and the other said end connecting to each said processor through said bus matrix; and
an interrupt generation unit, having two ends, with one said end connecting to said control logic unit, and the other said end connecting to each said processor through at least an interrupt signal line.

2. The device as claimed in claim 1, wherein said semaphore module register set further comprises:
a semaphore number register, for storing the number of the total said semaphores;
a processor number register, for storing the number of the total said processors in said system;
a random allocation register, for returning the index number of a non-allocated said semaphore after receiving a read operation from any said processor;
an allocated semaphore list register, for storing the bits representing the list of all said allocated semaphores;
an interrupt semaphore list register, for storing the bits representing the list of all said semaphores issuing interrupt signals;
an interrupt processor list register, for storing the bits representing the list of all said interrupted processors;
in interrupt clearance register, for writing the number of a processor for clearing the corresponding bit in said interrupt processor list register; and
a plurality of allocation registers, corresponding to said semaphores for indicating if said semaphore being allocated.

3. The device as claimed in claim 2, wherein said hardware semaphore device is arranged to set said allocation registers corresponding not-yet allocated semaphores to a default allocated value and set the corresponding bits in said allocated semaphore list register in order to execute a read operation by a random allocation request in said multi-processor system.

4. The device as claimed in claim 2, wherein said hardware semaphore device is arranged to set a said allocation register to a default allocated value in order to execute a read operation by said multi-processor system, and set a said allocation register to a default not-yet allocated value in order to execute a write operation by said multi-processor system.

5. The device as claimed in claim 1, wherein each said semaphore further comprises:
a remaining resource number register, for storing the number of the remaining units of corresponding said shared resource;
an initial resource number register, for storing the number of the un-used units of said shared resource in the initial allocation stage;
a waiting list register, for storing the bits representing the list of all said waiting processors on said semaphore;
a set waiting register, for setting the corresponding bit in said waiting list register; and
a clear waiting register, for clearing the corresponding bit in said waiting list register.

6. The device as claimed in claim 5, wherein said device is arranged to decrement the value in said remaining resource number register by 1 in order to execute a read operation to said remaining resource number register by said system.

7. The device as claimed in claim 5, wherein said device is arranged to increment the value in said remaining resource number register by 1 in order to execute a write operation to said remaining resource number register by said system.

8. The device as claimed in claim 7, wherein when the value in said remaining resource number register is equal to 1 and the content of said waiting list register indicates at least a said processor is waiting for said semaphore, said control logic unit adds the number of said semaphore to the corresponding bit in said interrupt semaphore list register and updates said interrupted processor list register according to the content of said waiting list register, and then arranges said interrupt generation unit to generate at least an interrupt signal according to the content of said interrupted processor list register.

9. The device as claimed in claim 1, wherein said device is installed in a said system implemented within an application specific integrated circuit or a system-on-a-chip.

10. The device as claimed in claim 1, wherein said device is installed in a said system implemented with a plurality of independent processors on individual chips.

11. A method for realizing a hardware semaphore device, applicable to a multi-processor system, said hardware semaphore device comprising a plurality of semaphores and a semaphore module register set, each said semaphore further comprising a remaining resource number register, a initial resource number register, a waiting list register, a set waiting register, said semaphore module register set further comprising a random allocation register, an interrupted processor list register, and a plurality of allocation registers, in the initialization stage of said system, said system allocating at least a said semaphore to connect to and manage at least a shared resource on said system, any said processor having to acquire said semaphore before using said shared resource, and releasing said semaphore after using said shared resource, and freeing corresponding semaphore when said shared resource no longer required to be managed.

12. The method as claimed in claim 11, wherein said allocation of a semaphore is categorized as random allocation and allocation of a specific semaphore, random allocation of a semaphore further comprises the steps of:
(a1) reading said random allocation register;
(a2) determining whether said read value equals to a default allocation failed value, if so, terminating said allocation; and
(a3) writing an initial number of un-used units of said shared resource into said initial resource number register of said semaphore.

13. The method as claimed in claim 11, wherein said allocation of a semaphore is categorized as random allocation and allocation of a specific semaphore, allocation of a specific semaphore further comprises the steps of:
(a1) reading a said specific allocation register;
(a2) determining whether said read value equals to a default allocation failed value, if so, terminating said allocation; and
(a3) writing an initial number of un-used units of said shared resource into said initial resource number register of said specific semaphore.

14. The method as claimed in claim 11, wherein said acquiring semaphore comprises the steps of:
(c1) reading said remaining resource number register of said semaphore;
(c2) determining whether said read value equals to a default acquisition success value; if so, starting using said shared resource and terminating;
(c3) determining whether repetitively reading said remaining resource number register of said semaphore, if so, returning to step (c1);
(c4) writing the number of said processor into said set waiting register, and waiting an interrupt signal.

15. The method as claimed in claim 11, wherein said releasing semaphore is to write any value into said remaining resource number register of said semaphore.

16. The method as claimed in claim 14, wherein after step (c4), when a said semaphore is released, said processor receives said interrupt signal from said device and performs the steps of:
(d1) reading interrupt semaphore list register, and writing the number of said processor into an interrupt clearance register;
(d2) acquiring said semaphore, and determining whether the acquisition being successful, if not, terminating; and
(d3) writing the number of said processor into said clearing wait register for clearing corresponding bit.

17. The method as claimed in claim 11, wherein said freeing semaphore is to write any value into an allocation register corresponding to said semaphore.
